(19) United States
(12) Patent Application Publication
(10) Pub. No.: US 2017/0236458 A1
(43) Pub. Date: Aug. 17, 2017

(54) MULTIFUNCTIONAL WINDOW/DOOR AND BUILDING HAVING WALL CONFIGURED USING SAME

(71) Applicant: Jae-Sik KIM, Daegu (KR)

(72) Inventor: Jae-Sik Kim, Daegu (KR)

(21) Appl. No.: 15/502,962

(22) PCT Filed: Aug. 11, 2014
(86) PCT No.: PCT/KR2014/007425

§ 371 Date: Feb. 9, 2017

(51) Int. Cl. G09F 11/08; G09F 19/22; G09F 9/302; G09F 19/12; G09F 11/10; E06B 7/00; G09F 11/02

(52) U.S. Cl. CPC G09F 11/08; E06B 7/00; G09F 19/226; G09F 11/025; G09F 19/12; G09F 11/10; G09F 9/302

(57) ABSTRACT

A multipurpose advertisement board comprising: a window; a vertical film comprising multiple film strips connected in series; a first image expression device comprising an operating unit rotatably connected to a vertical winding roller in upper and lower portions of the frame that vertically move the vertical film to display the multiple film strips in order; a horizontal film comprising multiple film strips connected in series; a second image expression device installed on the window frame, wherein the second image expression device comprises an operation unit rotatably connected to a horizontal winding roller installed in left and right portions of the window frame to rotate or release the horizontal film, thereby horizontally moving the horizontal film so that the multiple film strips of the horizontal film overlap with the film strips of the vertical film to make a combined image.

### TECHNICAL FIELD

The present invention relates to buildings with a multipurpose advertisement board having two films (one vertical; one horizontal) crossing to make various colors and images in the window on a wall of a building.

### BACKGROUND ART

In general, buildings have various windows and doors installed in openings to separate the interior from the exterior.

On the one hand, the most common form of windows and doors installed in the wall of a building is to install a window frame in the structure and to install a glass window in the frame to separate the interior from the exterior. Commonly, the glass window is either fixed in the frame or positioned in on the frame so that it moves to open and close.

To control the amount of sunlight that comes through windows, curtains, blinds, or roll screens are often installed, but this requires extra space and cost.

Still further, images of a particular product or company can be attached on the window for advertising purposes, but there are disadvantages such as the difficulty of changing the images and the loss of a clear view due to the attached images.

In the consideration of these issues, I previously invented a multipurpose advertisement board using a window, now U.S. Pat. No. 8,069,597 B2. This previous multipurpose advertisement board included winding rollers at the upper end and the lower end of the frame, and a film having multiple images. Such a multipurpose advertisement board has an advantage that it can display multiple images by simply rolling one of the rollers to wind the film, without a complicated preparation. However, such multipurpose advertisement board has a restricted advertising effect as it can only display a number of images in order. It cannot change the color of the image to adapt to the weather or the surroundings, or put dynamics to the image.

### TECHNICAL PROBLEM

The present invention has been devised in consideration of the aforementioned problems and situations, the objective of the present invention is to provide buildings with multipurpose advertisement boards that have two films between two glass plates within a window frame that move in different directions to display various images by intersecting one another.

### TECHNICAL SOLUTION

To achieve the objectives mentioned above the present invention includes a window frame with more than one glass plate attached to the window frame;

a vertical film that comprises multiple film 1 strips connected in a series;

a Vertical Winding Roller 1,2 that moves the vertical film to display the multiple film 1 strips in order, which are united with the vertical film and installed in the upper and lower frame of the window frame mentioned above;

Image Expression Device 1, installed in the upper window frame, comprising Operation Unit 1 combined with the Vertical winding roller 1,2 to rotate them;

Horizontal film comprising multiple Film Strips 2 connected in series;

Horizontal Winding roller 1,2, installed in the left and right frame of the window frame mentioned above, combined with the Horizontal Film to rotate or release the Horizontal

Film to make it move horizontally so that multiple film strips 2 overlap with the film strips 1 to make a combined Image;

Image Expression device 2 that is installed on the aforementioned window frame and comprises the Horizontal Winding roller 1,2 and the Operation Unit 2 combined with the Horizontal Winding roller 1,2;

Empty part, as one of the many Film strips 1, allowing light that comes in through the window without disruption by the vertical film to fill an area bigger than or equal to the area of the glass plate;

Empty part, as one of the many Film strips 2, allowing light that comes in through the window without disruption by the horizontal film to fill an area bigger than or equal to the area of the glass plate;

by overlapping the empty parts of the vertical film and the horizontal film, the multipurpose advertisement board can achieve a clear view for the users and influx of sunlight regardless of the vertical film and the horizontal film.

Also the present invention provides a multipurpose advertisement board that involves a Motor-controlled Unit comprising Operation Unit 1 and Operation Unit 2 that delivers rotary power to rotate the winding roller, and a Control unit that controls the Operation Unit 1 and the Operation Unit 2 to change the color of the combined image or to add animated effects on the combined image by changing either both or one of the film strips that overlap.

Also, the present invention provides a multipurpose advertisement board comprising:

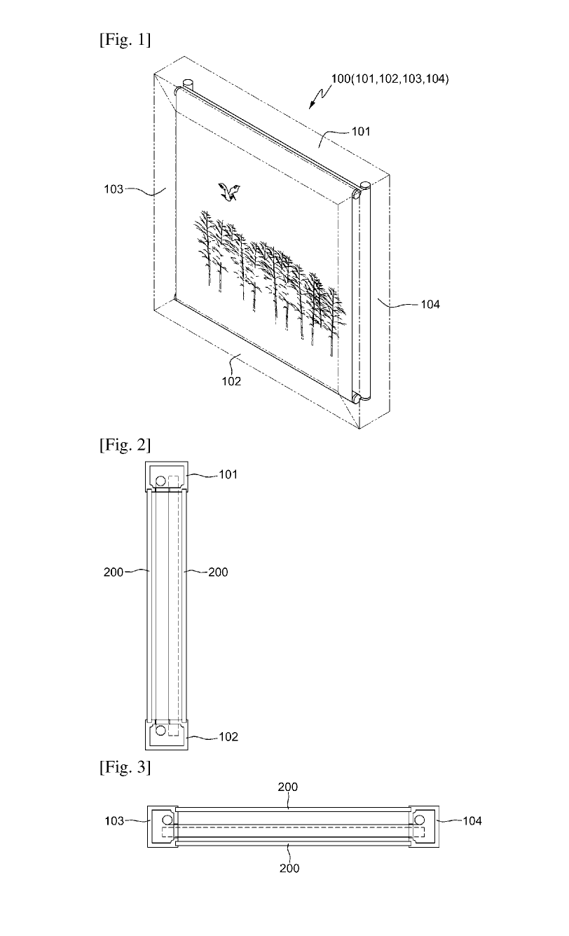

a multiple of FIG. 1 installed on the center of each film strip 1 located either on the left or the right of the Vertical film mentioned above;

FIG. 2 installed on the upper part of the Vertical Film, located either on the left or the right of the Vertical Film that FIG. 1 is not on;

FIG. 3 installed on the lower part of the Vertical Film on the same side as FIG. 2;

Sensor 1 that signals when it recognizes FIG. 1 as film strip 1 is on the right location within the window frame, installed on the window frame;

Sensor 2 that signals when it recognizes FIG. 2 as the Vertical Film is completely unrolled by the vertical winding roller 1, installed on the window frame close to the lower part of the Vertical winding roller 1;

Sensor 3 that signals when it recognizes FIG. 3 as the Vertical Film is completely unrolled by the Vertical winding roller 2, installed on the window frame close to the upper part of the Vertical winding roller 2;

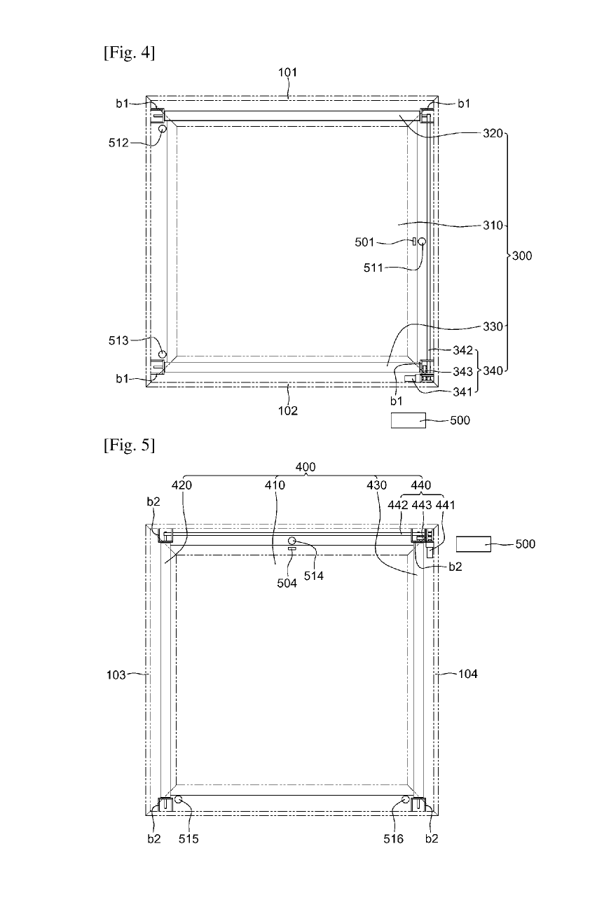

A multiple of FIG. 4 installed on the center of each film strip 2, located either on the upper or the lower part of the Horizontal Film mentioned above;

FIG. 5 installed on the left side of the Horizontal Film, located either on the upper or the lower part of the Horizontal Film that FIG. 4 is not on;

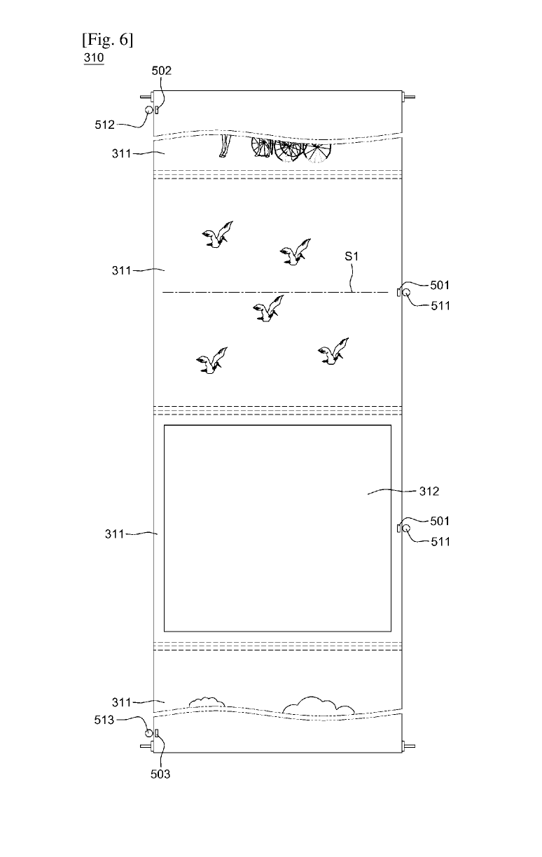

FIG. 6 installed on the right side of the Horizontal Film on the same side as FIG. 5;

Sensor 4 that signals when it recognizes FIG. 4 as Film strip 2 is on the right location within the window frame, installed on the window frame;

Sensor 5 that recognizes FIG. 5 as the Horizontal Film is completely unrolled by the Horizontal winding roller 1, located on the window frame close to the right side of the Horizontal winding roller 1;

Sensor 6 that signals when it recognizes FIG. 6 as the Horizontal Film is completely unrolled by the Horizontal winding roller 2, installed on the window frame close to the left side of the Horizontal winding roller 2;

Also, the present invention installs a plurality of the aforementioned multipurpose advertisement boards and the images of each board are combined to embody a whole complete image and an integrated controller that can control the whole image by controlling each of the advertisement boards, and buildings with walls with these boards.

Using the present invention with the aforementioned characteristics, one can increase the advertising effect by changing the color depending on the weather or the surrounding environment.

Also, by animating the images of each multipurpose advertisement board, one can make animated effects on the images.

### BRIEF DESCRIPTIONS OF THE DIAGRAMS

FIG. 1 is a Perspective view of the structure of the multipurpose advertisement boards when implemented desirably according to the present invention.

FIG. 2 is a side view of the structure of the multipurpose advertisement boards when implemented desirably according to the present invention.

FIG. 3 is a plane view of the of the structure of the multipurpose advertisement boards when implemented desirably according to the present invention.

FIG. 4 is a front view of the structure of the image expression device 1 according to the present invention.

FIG. 5 is a front view of the structure of the image expression device 2 according to the present invention.

FIG. 6 is a front view of the structure of the Vertical Film according to the present invention.

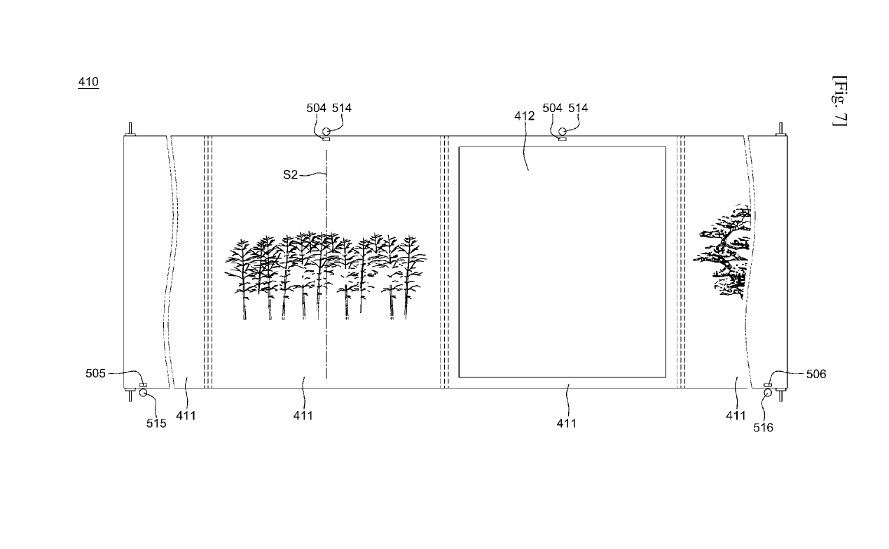

FIG. 7 is a front view of the structure of the Vertical Film according to the present invention.

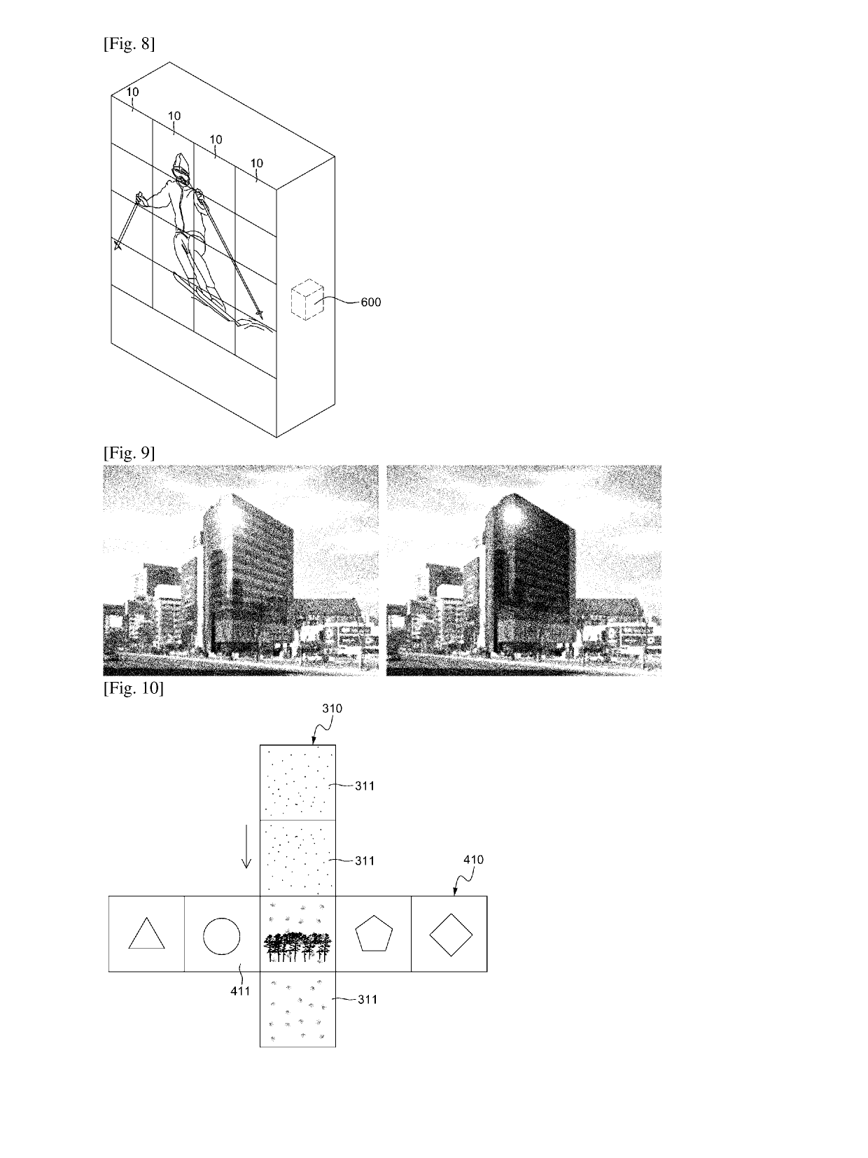

FIG. 8 is an example of a building with a side of wall consisted of the multipurpose advertisement boards according to the present invention.

FIG. 9 shows a building with a changed exterior/atmosphere by changing the color of the image created by the overlap of the Vertical film and the Horizontal film.

FIG. 10 shows the image created by the overlap with animated effects.

### ADDITIONAL DESCRIPTIONS OF THE MAIN PARTS OF THE DIAGRAMS

100: window frame

101: upper frame

102: lower frame

103: left frame

104: right frame

200: window glass

300: Image Expression device 1

310: Vertical Film

311: Film strip 1

312: Empty part

320: Vertical winding roller 1

330: Vertical winding roller 2

340: Operation Unit 1

400: Image Expression device 2

410: Horizontal Film

411: Film strip 2

412: Empty part

420: Horizontal winding roller 1

430: Horizontal winding roller 2

440: the second Operation unit

500: Control Unit

501: FIG. 1.

502: FIG. 2.

503: FIG. 3.

504: FIG. 4.

505: FIG. 5.

506: FIG. 6.

511: Sensor 1.

512: Sensor 2.

513: Sensor 3.

514: Sensor 4.

515: Sensor 5.

516: Sensor 6.

600: Integrated controller

### CONFIGURATION FOR THE IMPLEMENTATION OF THE INVENTION

The following is a detailed explanation of a desirable implementation of the present invention concerning the attached diagrams. In explaining the present invention, a detailed explanation of related functions and composition is omitted when judged it would unnecessarily disrupt the point of the present invention

A multipurpose advertisement board of the present invention with such characteristics comprising of window frame (100), glass plate (200), Image Expression Device 1 (300) assignment Image Expression Device 2 (400).

The aforementioned window frame (100) is consisted of a upper part frame (101), a lower part frame (102), a left frame (103), and a right frame (104), upper part frame (101) and lower part frame (102) are arranged in a horizontal structure and separate from each other, a left frame (103) is installed to connect the left side of the upper part frame (101) and the lower part frame (102), a right frame (104) is installed to connect the right side of the upper part frame (101) and the lower part frame (102).

The window frame (100) can be additionally installed on the structure of a building to constitute a window, or use a part of a wall of a building.

Glass plate (200) is installed on the window frame (100) to separate the interior and the exterior of a building. Such glass plate (200) is either consisted of a single plate, or of many plates with a gap between every two of them. A structure of a window frame with 2 glass plates is shows in D2 and D3.

Image Expression device 1 (300) expresses an image through the glass plate (200) installed in a window frame (100) and is consisted of a Vertical Film (310) Vertical winding roller 1,2 (320,330) and the Operation Unit 1 (340).

Vertical Film (310) is consisted of a multiple of Film strip 1 (311) connected in a series structure, more specifically, it is consisted of a multiple Film strip 1 (311), by connecting the upper part of a film strip 1 (311) to the lower part of another film strip 1 (311).

Besides, each Film strip 1 (311) comprises either a transparent, semitransparent, or a opaque material, and many film strip's 1 (311) do not have to be of the same material. Film Strip 1 (311) with transparent material, Film strip 1 (311) with semitransparent material, Film strip 1 (311) with opaque material can be used in combination to compose a Vertical Film (310).

Also, also different advertisement images and single color images can be printed on different film strip 1 (311) and among these film strip 1 (311) one of these can be chosen to be exposed to exterior through the glass plate (200).

Also, by installing Solar batteries in thin film on the part of the film strip, it is possible to generate electricity when necessary.

also by installing rear-projection screens on the part of the film strip 1 (311) and by protecting images from the inside using beam projectors on the screen, it is possible to Display various videos more easily.

Also it is possible to install LED in thin film or OLED in thin film on a part of Film strip 1 (311).

Also, a part of film strip 1 (311) comprises an empty part (312) so that light can penetrate through Film strip 1 (311) undisrupted. This empty part (312) is the same size and exterior of the glass plate or bigger. According to this structure, by locating the part of film strip 1 (311) with this empty part to be exposed through the glass plate, it is possible to have a clear view as the normal windows.

The connection between two film strips 1 (311) can be done by various methods such as glue, glue-tape, and needlework.

Vertical winding roller 1,2 (320,330) is connected with the Vertical Film (310), moves Vertical Film (310) in the vertical direction, and is installed on the upper part frame (101) lower part frame (102), which compose window frame (100).

Besides, D4 shows a structure with the upper part frame (101) installed on Vertical winding roller 1 (320), lower part frame (102) installed on the Vertical winding roller 2 (330), the upper part of the Vertical Film (310) combined with the Vertical winding roller 1 (320) to be rolled, and the lower part of the Vertical Film (310) combined with the Vertical winding roller 2 (330) to be rolled.

In this structure, when the upper part of Vertical Film (310) is rolled into the Vertical winding roller 1 (320), the lower part of the Vertical Film (310) rolled in the Vertical winding roller 2 (330) is unrolled, and vice versa.

Therefore, by adequately rolling and unrolling the Vertical Film (310) using Vertical winding roller 1,2 (320,330) and moving the Vertical Film (310) in the vertical direction, the Film strip 1 (311) is arranged to be explored through the glass plate (200).

Vertical winding roller 1 (320) and Vertical winding roller 2 (330) are fixed on the window frame (100) and are combined with the installed bracket (b1) with the left end and right end enabled to rotate.

Operation Unit 1 (340) is combined with the Vertical winding roller 1,2 (320,330) to rotate Vertical winding roller 1,2 (320,330).

This Operation Unit 1 (340) can be motor-operated using motors, or can be hand-controlled by using wires. The hand-controlled method using wire can be constituted by installing a chain wheel on the winding roller, and by allowing the wire of the chain to be rolled by the chain wheel so that the winding roller rolls to the direction of the wire pulled. Such hand-controlled method is a well-known method adapted in the widely used in window screens, so more detailed explanation is omitted.

Besides, the prior Operation Unit 1 (340) that uses motors is fixed on the window frame, and can comprise a motor 1 (341) and chain 1 (342) that delivers the rotary power by the operation of motor 1 (341) to the Vertical winding roller 1 (320) by connecting motor 1 (341) and the Vertical winding roller 1 (320), and chain 2 (343) that delivers the rotary power by the operation of motor 1 (341) to the Vertical winding roller 2 (330) by connecting motor 1 (341) and the Vertical winding roller 2 (330).

Surely, a belt can be used instead of the chain 1,2 (342,343)

Besides, it is possible to install motor 1 (341) in each Vertical winding roller 1,2 (320,330), and in this case, installation of chain 1,2 (342,343) is not demanded.

When Operation Unit 1 (340) is composed to be motor-operated using a motor as described above, Control Unit (500) is included for controlling Operation Unit 1(340) and Operation Unit 2 (440) that will be addressed later.

The Control Unit (500) changes the color of the image or add animated effects on the image that is created by the overlap of the Film strip 1 (311) and the Film strip 2 (411) exposed to the exterior through the glass plate (200) by controlling the Operation Unit 1 (340) and the Operation Unit 2 (440).

The Image Expression device 2 (400), just the same as Image Expression device 1 (300), arranges image that is exposed through glass plate (200), overlaps this image on the other image arranged by Image Expression device 1 (300) through the glass plate (200), and creates a new combined color or image, or have animated effects on the image by the combination of the two images. The aforementioned ‘animated effects’ makes the image seem moving to the observers by moving the image that works as the background, or by moving the image that works as foreground, independent from the background. Such animated effects can be achieved by appropriately controlling the Operation Unit 1 (340) and the Operation Unit 2 (440).

This Image Expression device 2 (400) is consisted of the Horizontal Film (410), Horizontal winding roller 1,2 (420,430), and Operation Unit 2 (440).

The Horizontal Film (410) has a multiple of Film strips 2 (411) connected in a series structure, more specifically, it has multiple Film strips 2 (411), by connecting the left part of one film strip 2 (411) to the right part of another film strip 2 (411).

Each Film strip 2 (411) is, a same as the Film strip 1 (311), having a transparent, semitransparent, or opaque material. On each Film strip 2 (411), a single color image or an advertisement image is printed.

Also, on a part of Film strip 2 (411), solar cell in thin film, LED in thin film, OLED in thin film can be installed, or rear-projection screens can be arranged.

Also, an Empty part (412) is arranged on a part of Film strip 2 (411) in the same structure as an empty part (312) is arranged in Film strip 1 (311).

Therefore, a clear view can be achieved through the window by moving the Vertical film and the Horizontal film to locate the empty part (312) of the Vertical Film (310) and the empty part (412) of the Horizontal Film (410) in the window frame.

The connection between two film strip 2 (411) can be done by various methods such as glue, glue-tape, and needlework.

The Horizontal Film (410) as arranged above is installed in front or the rear of the Vertical Film (310) to overlap with the Film strip 1 (311) of Vertical Film (310). On D1 and D3, the structure in which the Horizontal Film (410) is installed in the rear of the Vertical Film (310) is displayed.

The Horizontal winding roller 1,2 (420,430) are connected with the Horizontal Film (410) to move the Horizontal Film (410) to left and right, and are installed on the left frame (103) and the right frame (104) that constitute the window frame (100).

Besides, on D5, a structure in which the Horizontal winding roller 1 (420) is installed on the left frame (103), the Horizontal winding roller 2 (430) is installed on the right frame (104), the left side of the Horizontal Film (410) is connected to the Horizontal winding roller 1 (420), and the right side of the Horizontal Film (410) is connected to the Horizontal winding roller 2 is displayed.

In such structure, when the left side of the Horizontal Film (410) is rolled into the Horizontal winding roller 1 (420), the right side of the Horizontal Film (410) is unrolled from the Horizontal winding roller 2 (430), and when the right side of the Horizontal Film (410) is rolled into the Horizontal winding roller 2 (430), the left side of the Horizontal Film (410) is unrolled from the Horizontal winding roller 1 (420).

Therefore, by adequately rolling and unrolling the Horizontal Film (410) using Horizontal winding roller 1,2 (420,430) and moving the Horizontal Film (410) in the horizontal direction, the Film strip 2 (411) is arranged to be explored through the glass plate (200).

These Horizontal winding roller 1 (420) and Horizontal winding roller 2 (430) are fixed on the window frame (100) and are combined with the installed bracket (b2) with the left end and right end enabled to rotate.

Operation Unit 2 (340) is combined with the Horizontal winding roller 1,2 (420,430) to rotate the Horizontal winding roller 1,2 (420,430).

This Operation Unit 2 (440) can be composed to be, just like the aforementioned Operation Unit 1 (340), hand-controlled or motor-controlled. Besides, the prior Operation Unit 2 (340) that is motor-controlled and fixed on the window frame (100) can be consisted of motor 2 (441), chain 3 (442) that delivers the rotary power by the operation of motor 2 (441) to the Horizontal winding roller 1 (420) by connecting motor 2 (441) and the Horizontal winding roller 1 (420), and chain 4 (443) that delivers the rotary power by the operation of motor 2 (441) to the Horizontal winding roller 2 (430) by connecting motor 2 (441) and the Horizontal winding roller 2 (430).

Surely, a belt can be used instead of the chain 3,4 (442,443)

Besides, the motor 2 (441) can be installed in each Horizontal winding roller 1,2 (420,430), and in this case, the installment of chain 3,4 (442,443) is not demanded.

This motor-controlled Operation Unit 2 (440) is controlled by the Control Unit (500) that was explained above.

When the Operation Unit 1 (340) and the Operation Unit 2 (440) are arranged to be motor-controlled as described above, FIG. 1, 2, 3, 4, 5, 6 (501,502,503,504,505,506) and Sensor 1,2,3,4,5,6 (511,512,513,514,515,516) are included to locate the Film strip 1 (311) and the Film strip 2 (411) within the window frame (100) correctly so that the image or the additional functionalities (solar batteries in thin film, a rear-projection screen, solar cell in thin film, LED in thin film, OLED in thin film can be completely exposed through the glass plate (200), and to prevent the Vertical Film (310) and the Horizontal Film (410) from getting damaged as they are excessively unrolled by the Vertical winding roller 1,2 (320,330) and the Horizontal winding roller 1,2 (420,430).

In this case, the Sensor 1,2,3,4,5,6 (511,512,513,514,515,516) can be constituted with photo sensors, and correspondingly the FIG. 1,2,3,4,5,6 (501,502,503,504,505,506) can be constituted with a reflection board that reflect the light comes from the photo sensor to return it to the photo sensors, or can be constituted with touch-sensor such as a Limit Switch instead of the non-touch sensor above.

More specifically, FIG. 1 (501) comes in plurality, and each FIG. 1 (501) is installed on either the left or the right side of the Vertical Film (310) to be placed on the center of the Film strip 1 (311). The center of the Film strip 1 (311) mentioned here refers to the location that corresponds to the Horizontal line (51) that divides the Film strip 1 (311) into upper half and lower half. In D6, a structure in which FIG. 1 (501) is installed in the right center of each Film strip 1 (311) is displayed.

Sensor 1 (511) that corresponds to this FIG. 1 (501) is installed on the window frame (100) to recognize FIG. 1 (501) and signal when the film strip 1 (311) is located correctly for the image created by the film strip 1 (311) to be completely exposed through the glass plate (200).

Therefore, when the Vertical Film (310) moves vertically, the desired Film strip 1 (311) controlled to be exposed through the glass plate (200) using the signal that comes from the sensor 1 (511).

The FIG. 2 (502) is located either on the left or the right of the Vertical Film (310), whichever the FIG. 1 (501) is not installed, on the upper part of the Vertical Film (310). On D6, a structure in which FIG. 2 (502) is installed on the upper left part of the Vertical Film (310) is displayed.

Sensor 2 (512) that corresponds to this FIG. 2 (502) is installed on the window frame (100) to recognize FIG. 2 (502) and signal when the Vertical Film (310) is completely unrolled from the Vertical winding roller 1 (320).

Therefore, when the Vertical Film (310) is completely unrolled from the Vertical winding roller 1 (320), it is possible to prevent the Vertical Film (310) from getting damaged when it is to be excessively unrolled, by stopping the rotation of the Vertical winding roller 1, 2 (320,330) using the signal that comes from the Sensor 2 (512).

The FIG. 3 (503) is installed on the lower part of the Vertical Film (310), on the same side as FIG. 2 (502). On D6, a structure in which FIG. 3 (503) is installed on the lower left part of the Vertical Film (310) is displayed.

Sensor 3 (513) that corresponds to this FIG. 3 (503) is installed on the window frame (100) to recognize FIG. 3 (503) to signal when the Vertical Film (310) is completely unrolled from the Vertical winding roller 2 (330).

Therefore, when the Vertical Film (310) is completely unrolled from the Vertical winding roller 2 (330), it is possible to prevent the Vertical Film (310) from getting damaged when it is to be excessively unrolled, by stopping the rotation of Vertical winding roller 1,2 (320,330) using the signal that comes from the Sensor 3 (513).

FIG. 4 (504) comes in plurality, and each FIG. 4 (504) is installed on either the upper or the lower part of the Horizontal Film (410), and on the center of the Film strip 2 (411). The center of the Film strip 2 (411) mentioned here refers to the location that corresponds to the Strip 2 (411) into the left half and the right half. In D7, a structure in which FIG. 4 (504) is installed in the upper center of each Film strip 2 (411) is displayed.

Sensor 4 (514) that corresponds to this FIG. 4 (504) is installed on the window frame (100) to recognize FIG. 4 (501) and signal when the film strip 2 (411) is located correctly for the image created by the film strip 4 (411) to be completely exposed through the glass plate (200).

Therefore, when the Horizontal Film (410) moves horizontally, the desired Film strip 2 (411) controlled to be exposed through the glass plate (200) using the signal that comes from the sensor 4 (514).

The FIG. 5 (505) is located either on the upper part or the lower part of the Horizontal Film (410), whichever the FIG. 4 (504) is not installed, on the left part of the Horizontal Film (410). On D7, a structure in which FIG. 5 (505) is installed on the lower left part of the Horizontal Film (410) is displayed.

Sensor 5 (515) that corresponds to this FIG. 5 (505) is installed on the window frame (100) to recognize FIG. 5 (505) and signal when the Horizontal Film (410) is completely unrolled from the Horizontal winding roller 1 (420).

Therefore, when the Horizontal Film (410) is completely unrolled from the Horizontal winding roller 1 (420), it is possible to prevent the Horizontal Film (410) from getting damaged when it is to be excessively unrolled, by stopping the rotation of the Horizontal winding roller 1,2 (420,430) using the signal that comes from the Sensor 5 (515)

The FIG. 6 (506) is installed on the right part of the Horizontal Film (410), on the same side as FIG. 5 (505). On D7, a structure in which FIG. 6 (506) is installed on the lower right part of the Horizontal Film (410) is displayed.

Sensor 6 (516) that corresponds to this FIG. 6 (506) is installed on the window frame (100) to recognize FIG. 6 (506) to signal when the Horizontal Film (410) is completely unrolled from the Horizontal winding roller 2 (430).

Therefore, when the Horizontal Film (410) is completely unrolled from the Horizontal winding roller 2 (430), it is possible to prevent the Horizontal Film (410) from getting damaged when it is to be excessively unrolled, by stopping the rotation of Horizontal winding roller 1,2 (420,430) using the signal that comes from the Sensor 6 (516).

The signal that comes from the Sensor 1,2,3,4,5,6 (511,512,513,514,515,516) is delivered to the Control Unit (500), and using this signal, the Control Unit (500) controls the Operation Unit 1 (340) and the Operation Unit 2 (440).

D8 shows an example that has arranged a wall of a building using the multipurpose advertisement board of the present invention.

When arranging a wall of a building using the multipurpose advertisement board as above, a multiple of multipurpose advertisement boards (10) can be arranged in a structure that each board adjoining another on the wall.

A whole image can be expressed by using the multiple of the multipurpose advertisement boards by arranging them on a wall of a building.

For this purpose, the intended image has to be divided into pieces that corresponds to the number of the multipurpose advertisement boards, the Film strip 1 (311) of the Vertical Film (310) and the Film strip 2 (411) of the Horizontal Film (410) is composed using the divided images, and each multipurpose advertisement board is controlled to expose the Film strip 1 (311) and the Film strip 2 (411) through the glass plate (200).

In this case, an integrated controller (600) is additionally equipped to control the multiple multipurpose advertisement boards installed on the wall of the building, and this integrated controller (600) is connected to the Control Units (500) of each multipurpose advertisement board to control each multipurpose advertisement board.

Explanation for the operation effects of a building that has a wall arranged by the multipurpose advertisement boards of the present invention

When it is judged that there is an issue with getting a clear view or getting enough sunlight coming in due to the Vertical Film (310) and the Horizontal Film (410), the vertical film and the horizontal film can be moved so that the empty parts (312,412) of the Film strip 1 (311) and the Film strip 2 (411) are exposed through the glass plate (200). The Vertical film (310) and the horizontal film (410) are not seen within the window frame (100), so the Vertical Film (310) and the Horizontal Film (410) prevented from disrupting the user view or blocking the sunlight. In other words, it is possible to use as a normal window.

D9 is a blueprint that shows the state of the building that has changed due to the combined image by the overlap of the vertical film (310) and the horizontal film (410).

Film strip 1 (311) and Film strip 2 (411) consisted of transparent or semi-transparent material and printed difference single color Images.

As mentioned above, it is possible to express a new color by combining the two colors. Therefore, it is possible to easily change the color of the image that is expressed through the window by moving the Vertical Film (310) and the Horizontal Film (410) so that the other Film strip 1 (311) and the Film strip 2 (411) of different colors are overlapped within the window frame (100), or by moving one of the Vertical Film (310) and the Horizontal Film (410) so that one of the Film strip 1 (311) and the Film strip 2 (411) is changed to another film strip of another color using the Control Unit (500) and the Operation Unit 1,2 (340,440).

The method of expressing a new color by combining two colors has an advantage of being able to Express more various colors than the method of exchanging a single color image to another color so that it can adapted to the surrounding environment or the weather more aptly.

D10 is a blueprint of a state in which the combined image has got an animated effect.

For example, have the Film strip 1 (311) of the Vertical Film (310) that is on the front side of the window be consisted of a transparent material, and print images of snow and fallen leaves.

Also, print images of nature, buildings, people or animals for background images the Film strip 2 (411) of the Horizontal Film (410) that is on the rear side of the window.

Move the Vertical Film (310) and the Horizontal Film (410) so that Film strip 1 (311) and Film strip 2 (411) arranged as above are correctly located within the window frame (100). Then, while the Horizontal Film (410) is fixed, by moving the Vertical Film (310) down, effects of snow and leaves falling and effects of a changes in seasons can be expressed.

Since the duration of the effect is proportional to the amount of the number of printed Film strip 1 (311) with snow or leaves images, by having an appropriate number of film strips, it is possible to determine the duration of the effects.

Likewise, by printing images of nature on Film strip 2 (411) and having Film strip 1 (311) fixed, it is possible to achieve an effect of images of Film strip 1 (311) moving by only moving the Film strip 2 (411).

The present invention has been explained above with reference to embodiments thereof, but the present invention is not limited to the above-described embodiments. In concluding the detailed description, those skilled in the art will appreciate that many variations and modifications can be made to the preferred embodiments without departing from the principles of the present invention. Therefore, it will be readily understood that such variations and modifications to the preferred embodiment are within the scope of the present invention as in the claims.

1. A multipurpose advertisement board comprising:
a window frame with more than one installed glass plate;
a vertical film comprising multiple film strips connected in series, wherein one of the film strips comprises an empty strip equal to or larger than the glass plates to allow light to pass through without disruption;
a first image expression device comprising an operating unit rotatably connected to a vertical winding roller in upper and lower portions of the frame that vertically move the vertical film to display the multiple film strips 1 in the series;
a horizontal film comprising multiple film strips connected in series, wherein one of the film strips of the horizontal film comprises an empty strip equal to or larger than the glass plates to allow light to pass through without disruption; and
a second image expression device comprising an operation unit rotatably connected to a horizontal winding roller installed in left and right portions of the window frame to rotate or release the horizontal film, thereby horizontally moving the horizontal film so that the multiple film strips of the horizontal film overlap with the film strips of the vertical film to make a combined image.

2. The multipurpose advertisement board of claim 1, wherein each operation unit is a motor-controlled unit that delivers rotary power to rotate the winding roller, the multipurpose advertisement board further comprising a control unit that controls the operation units to change the color of the combined image or to add animated effects on the combined image by changing either or both of the film strips that overlap.

3. The multipurpose advertisement board of claim 2, further comprising:
a first vertical position marker installed vertically at a center of each vertical film strip and horizontally at either the left or the right of the vertical film;
a second vertical position marker installed on the upper part of the vertical film, and horizontally opposite to the first vertical position marker;
a third vertical position marker installed on the lower part of the vertical film and on the same horizontal side as the second vertical position marker;
a first vertical sensor that signals when it recognizes the first vertical position marker at a predetermined location within the window frame;
a second vertical sensor that signals when it recognizes the second vertical position marker at a lower portion of the window frame as the vertical film is completely unrolled by the vertical winding roller nearest the lower part of the window frame;
a third vertical sensor that signals when it recognizes the third vertical position marker at an upper portion of the window frame as the vertical film is completely unrolled by the vertical winding roller nearest the upper part of the window frame;
a first horizontal position marker installed horizontally at the center of each horizontal film strip and vertically at the upper or the lower part of the horizontal film;
a second horizontal position marker installed on a left side of the horizontal film and vertically opposite to the first horizontal position marker;
a third horizontal position marker installed on a right side of the horizontal film and vertically on a same side as the second horizontal position marker;
a first horizontal sensor that signals when it recognizes the first horizontal position marker is at a predetermined location within the window frame, installed on the window frame;
a second horizontal sensor that recognizes the second horizontal sensor as the horizontal film is completely unrolled by the horizontal winding roller located nearest the right side of the window frame; and
a third horizontal sensor that signals when it recognizes the third horizontal sensor as the horizontal film is completely unrolled by the horizontal winding roller nearest the left side of the window frame.

4. A building comprising a wall arranged by a plurality of multipurpose advertisement boards of claim 1,
wherein the plurality of multipurpose advertisement boards express one whole image created by many images, each expressed by a different multipurpose advertisement board, and
wherein the building further comprises an integrated controller that controls the image expressed by the multiple multipurpose advertisement boards by controlling each of the multiple multipurpose advertisement boards.
